(19) United States
(12) Patent Application Publication
(10) Pub. No.: US 2008/0229949 A1
(43) Pub. Date: Sep. 25, 2008

(54) Liquid transfer apparatus

(75) Inventors: Hirofumi Saito, Ibaraki (JP); Yoshihito Nakamura, Ibaraki (JP); Akihiro Matsukawa, Ibaraki (JP); Katsuhisa Nakamura, Ibaraki (JP); Masaaki Asami, Ibaraki (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Komori Corporation

(21) Appl. No.: 12/077,165

(22) Filed: Mar. 17, 2008

(30) Foreign Application Priority Data
Mar. 20, 2007 (JP) 072155/2007

(51) Int. Cl. B41F 1/46

(52) U.S. Cl. 101/363

(57) ABSTRACT

A liquid transfer apparatus includes a supply cylinder and viscosity reducing agent supply unit. The supply cylinder comes into contact with a transfer target body and supplies a transfer liquid to the transfer target body. The viscosity reducing agent supply unit supplies a viscosity reducing agent which reduces a viscosity of the transfer liquid to the supply cylinder after the apparatus emergently stops and before the supply cylinder starts transfer.

### BACKGROUND OF THE INVENTION

The present invention relates to a liquid transfer apparatus which performs transfer (coating/printing) by supplying a transfer liquid (varnish/ink) to a transfer target body (sheet/web).

In general, a liquid transfer apparatus comprises a first blanket cylinder to which a varnish supply device supplies varnish, a second blanket cylinder which opposes the first blanket cylinder, a varnish supply cylinder which opposes the second blanket cylinder and transfers the varnish to it, and a liquid supply device which supplies to an impression cylinder and the varnish supply cylinder a varnish anti-drying liquid to prevent the varnish from drying. In this arrangement, as a sheet/web passes between the first and second blanket cylinders, the two surfaces of the sheet/web are coated with the varnish.

In a conventional liquid transfer apparatus, as disclosed in Japanese Patent Laid-Open No. 2006-56055, a varnish anti-drying liquid is supplied to an impression cylinder and varnish supply cylinder immediately after the start of coating and at the end of coating when the amount of varnish transferred to the impression cylinder and varnish supply cylinder becomes unstable and insufficient. This prevents the varnish from drying, so the sheet/web will not stick to the blankets of the first and second blanket cylinders.

In the conventional liquid sifting apparatus (coating apparatus) described above, when the apparatus stops for some reason during coating, varnish in an amount sufficient for coating is attached to the circumferential surfaces of the impression cylinder and varnish supply cylinder, unlike immediately after coating and at the end of coating. If the coating apparatus is stopped and the varnish is left unconsumed by the sheet/web for a long period of time, the varnish on the surface of the cylinder gradually dries and its viscosity increases. With an increased viscosity, the tackiness of the varnish or its adhesive force to adhere the sheet or web increases, so the varnish serves as an adhesive. In this state, if coating is resumed and a printing pressure is applied to on the sheet, the sheet/web may stick to the varnish supply cylinder undesirably.

Once the sheet/web sticks to the varnish supply cylinder, to remove it from the varnish supply cylinder requires much labor and time. In a double-sided coating apparatus which coats the two surfaces of a sheet, due to a varnish transferred to the circumferential surface of a blanket cylinder that holds and conveys the sheet, the sheet may be undesirably conveyed while sticking to the blanket cylinder. These problems also occur in a printing apparatus which prints using high-viscosity ink.

### SUMMARY OF THE INVENTION

It is an object of the present invention to prevent a sheet/web from sticking to a supply cylinder when coating/printing is to be resumed after an emergency stop of a printing apparatus.

In order to achieve the above object, according to the present invention, there is provided a liquid transfer apparatus comprising a supply cylinder which comes into contact with a transfer target body and supplies a transfer liquid to the transfer target body, and viscosity reducing agent supply means for supplying a viscosity reducing agent which reduces a viscosity of the transfer liquid to the supply cylinder after the apparatus stops emergently and before the supply cylinder starts transfer.

### BRIEF DESCRIPTION OF THE DRAWINGS

FIG. 1 is a side view showing a sheet-fed rotary printing press as a whole;

FIG. 2 is a side view of a coating apparatus to which a liquid transfer apparatus according to an embodiment of the present invention is applied;

FIG. 3 is a side view of the main part which describes a throw-on/off mechanism for an upper blanket cylinder shown in FIG. 2;

FIG. 4 is a side view of the main part which describes a throw-on/off mechanism for an anilox roller shown in FIG. 2;

FIG. 5 is a view seen from the direction of an arrow IV in FIG. 2;

FIG. 6 is a block diagram showing the electrical configuration of the liquid transfer apparatus shown in FIG. 2;

FIG. 7 is a flowchart to explain the coating operation of the liquid transfer apparatus shown in FIG. 6;

FIG. 8 is a flowchart to explain in detail upper spray control (pre-coating) shown in FIG. 7;

FIG. 9 is a flowchart to explain in detail lower spray control (pre-coating) shown in FIG. 7;

FIG. 10 is a flowchart to explain in detail impression throw-on shown in FIG. 7;

FIG. 11 is a flowchart to explain in detail impression throw-off shown in FIG. 7;

FIG. 12 is a flowchart to explain the emergency impression throw-off operation of the coating apparatus shown in FIG. 2;

FIG. 13 is a flowchart to explain coating resume operation of the liquid transfer apparatus shown in FIG. 6;

FIG. 14 is a flowchart to explain in detail upper spray control (after emergency impression throw-off) shown in FIG. 13; and

FIG. 15 is a flowchart to explain in detail lower spray control (after emergency impression throw-off) shown in FIG. 13.

### DESCRIPTION OF THE PREFERRED EMBODIMENT

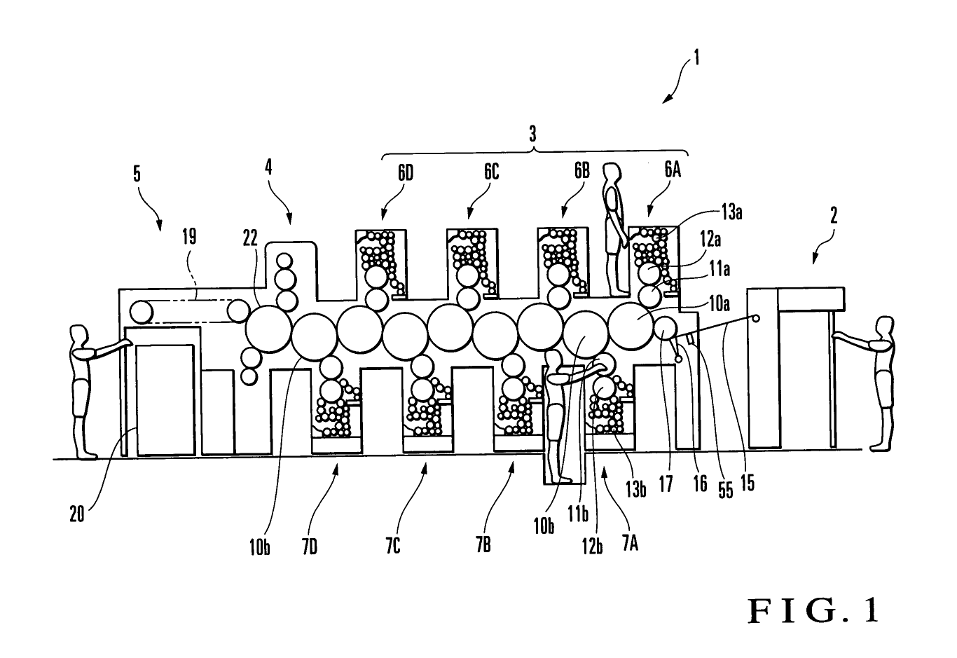

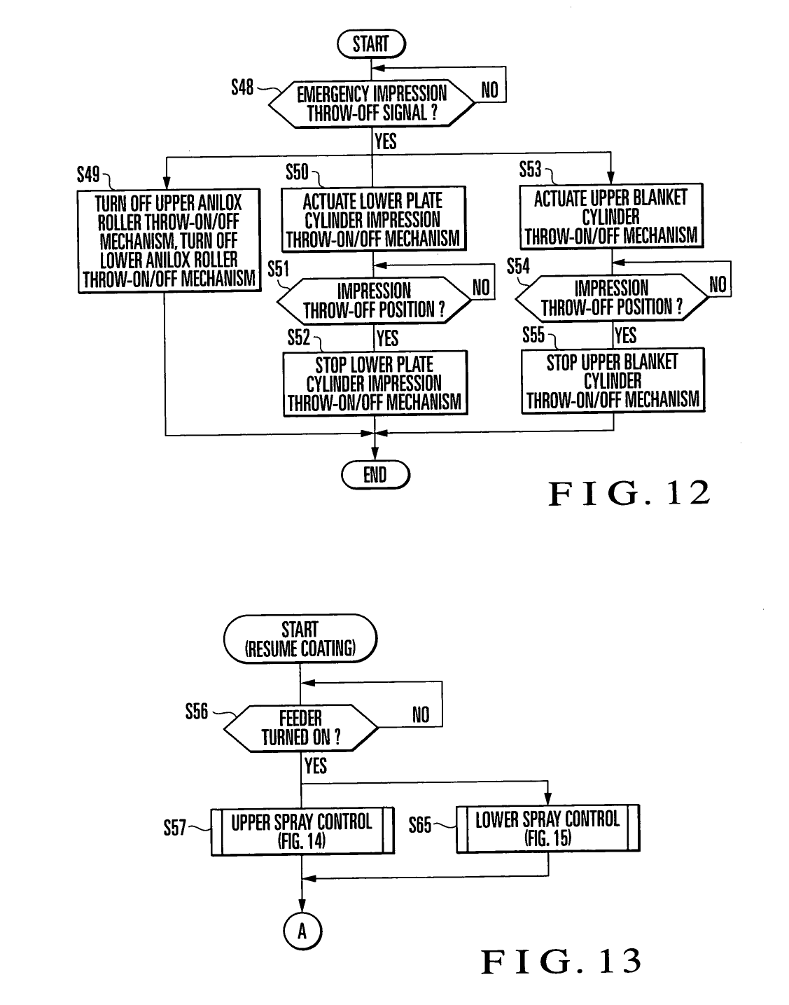

A liquid transfer apparatus according to an embodiment of the present invention will be described in detail with reference to FIGS. 1 to 15.

### [Sheet-Fed Rotary Printing Press]

As shown in FIG. 1, a sheet-fed rotary printing press 1 comprises a feeder 2 which feeds a sheet (transfer target body), a printing unit 3 which prints the sheet fed from the feeder 2, a coating unit 4 which coats the obverse and reverse of the sheet printed by the printing unit 3 with varnish, and a delivery unit 5 to which the sheet coated by the coating unit 4 is delivered. The printing unit 3 comprises first to fourth obverse printing units 6A to 6D and first to fourth reverse printing units 7A to 7D. The sheet-fed rotary printing press 1 serves as a liquid transfer machine. The feeder 2 serves as a supply unit. The printing unit 3 and coating unit 4 serve as a liquid transfer unit. The delivery unit 5 serves as a discharge unit.

Each of the four obverse printing units 6A to 6D comprises an impression cylinder 10a having a gripper unit in its circumferential surface to grip a sheet, a blanket cylinder 11a opposing the upper portion of the impression cylinder 10a, a plate cylinder 12a opposing the upper portion of the blanket cylinder 11a, and an ink supply unit 13a which supplies ink (transfer target liquid) to the plate cylinder 12a. The impression cylinder 10a comprises a double-diameter cylinder having a diameter twice that of the plate cylinder 12a. The gripper unit serves as a holding unit. The impression cylinder 10a serves as a transport cylinder. The blanket cylinder 11a serves as a printing cylinder and a supply cylinder which supplies ink.

Each of the four reverse printing units 7A to 7D comprises an impression cylinder 10b having a gripper unit in its circumferential surface to grip a sheet, a blanket cylinder 11b opposing the lower portion of the impression cylinder 10b, a plate cylinder 12b opposing the lower portion of the blanket cylinder 11b, and an ink supply unit 13b which supplies the ink to the plate cylinder 12b. The impression cylinder 10b comprises a double-diameter cylinder having a diameter twice that of the plate cylinder 12b. The gripper unit serves as a holding unit. The impression cylinder 10b serves as a transport cylinder. The blanket cylinder 11b serves as a printing cylinder and a supply cylinder which supplies ink.

In this arrangement, the leading edge of a sheet fed from the feeder 2 onto a feeder board 15 is gripped by a swing arm shaft pregripper 16 and then gripping-changed to the gripper of a transfer cylinder 17. The sheet gripping-changed to the gripper of the transfer cylinder 17 is gripping-changed to the gripper of the impression cylinder 10a of the obverse printing unit 6A and printed with the first color on its obverse as the sheet passes through the opposing point (nip) of the impression cylinder 10a and blanket cylinder 11a. Then, the sheet printed with the first color on the obverse is gripping-changed to the impression cylinder 10b of the reverse printing unit 7A and printed with the first color on its reverse as the sheet passes through the opposing point of the impression cylinder 10b and blanket cylinder 11b.

Subsequently, the sheet which is sequentially printed with the respective colors on each of its obverse and reverse by the obverse printing units 6B to 6D and reverse printing units 7B to 7D is coated with varnish on the obverse and reverse by the coating unit 4. The coated sheet is gripping-changed to the delivery gripper (not shown) of a delivery chain 19 of the delivery unit 5 and conveyed by the delivery chain 19. The sheet conveyed by the delivery chain 19 serving as a delivery means is dropped onto a delivery pile 20 and stacked there.

### [Coating Unit]

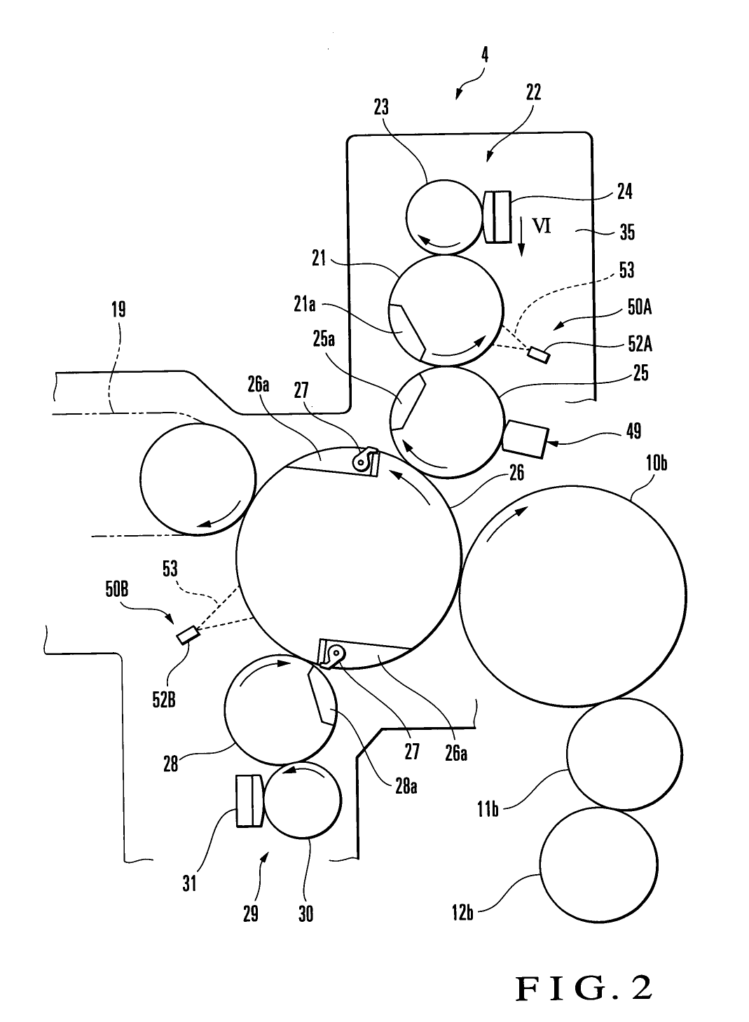

The coating unit 4 will be described with reference to FIG. 2. As shown in FIG. 2, an upper plate cylinder 21 (first cylinder) has a notch 21a extending in the axial direction in part of its circumferential surface. A varnish supply device 22 (first liquid supply means) which supplies the varnish to the upper plate cylinder 21 comprises an anilox roller 23 which is arranged to oppose the upper plate cylinder 21 and a chamber coater 24 which supplies the varnish to the anilox roller 23. An upper blanket cylinder 25 (second cylinder) arranged to oppose the upper plate cylinder 21 and a blanket cylinder 26 (third cylinder) has a notch 25a extending in the axial direction in part of its circumferential surface. The blanket cylinder 26 and upper blanket cylinder 25 serve as a supply cylinder which supplies varnish.

The blanket cylinder 26 has notches 26a extending in the axial direction at positions that halve the circumferential surface in the circumferential direction. Each notch 26a is provided with a gripper unit 27 (sheet holding means) having a gripper pad, which grips and conveys the sheet, and a gripper. A lower plate cylinder 28 arranged to oppose the blanket cylinder 26 has a notch 28a extending in the axial direction in part of its circumferential surface. A varnish supply device 29 (second liquid supply means) which supplies the varnish to the lower plate cylinder 28 comprises an anilox roller 30 arranged to oppose the lower plate cylinder 28, and a chamber coater 31 which supplies the varnish to the anilox roller 30.

The blanket cylinder 26 is arranged to oppose the impression cylinder 10b of the reverse printing unit 7D which serves as the most-downstream transport cylinder of the printing unit 3 in the sheet convey direction. The upper blanket cylinder 25 and blanket cylinder 26 are arranged to oppose each other in the downstream sheet convey direction from a position where the impression cylinder 10b of the reverse printing unit 7D opposes the blanket cylinder 26. The lower plate cylinder 28 and blanket cylinder 26 are arranged to oppose each other in the upstream sheet convey direction from a position where the impression cylinder 10b of the reverse printing unit 7D opposes the blanket cylinder 26.

In this arrangement, the varnish supplied from the chamber coater 24 to the anilox roller 23 is transferred to the upper blanket cylinder 25 through the upper plate cylinder 21. When the printed sheet passes through the opposing point of the upper blanket cylinder 25 and blanket cylinder 26, its obverse (one surface) is coated. Simultaneously, the varnish transferred from the lower plate cylinder 28 to the circumferential surface of the blanket cylinder 26 by the printing pressure of the upper blanket cylinder 25 coats the reverse (the other surface) of the printed sheet.

### [Blanket Cylinder Throw-On/Off Mechanism]

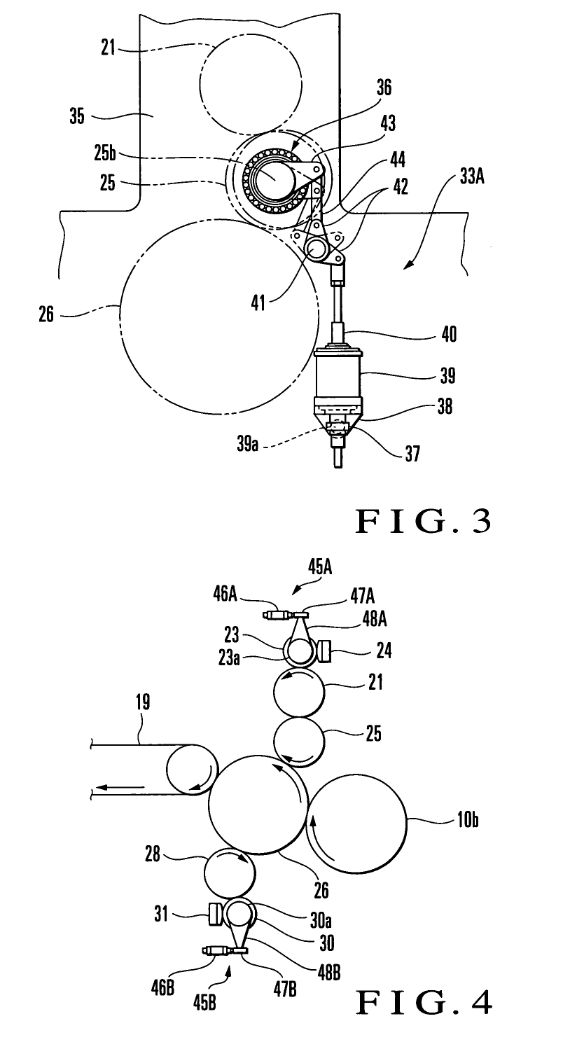

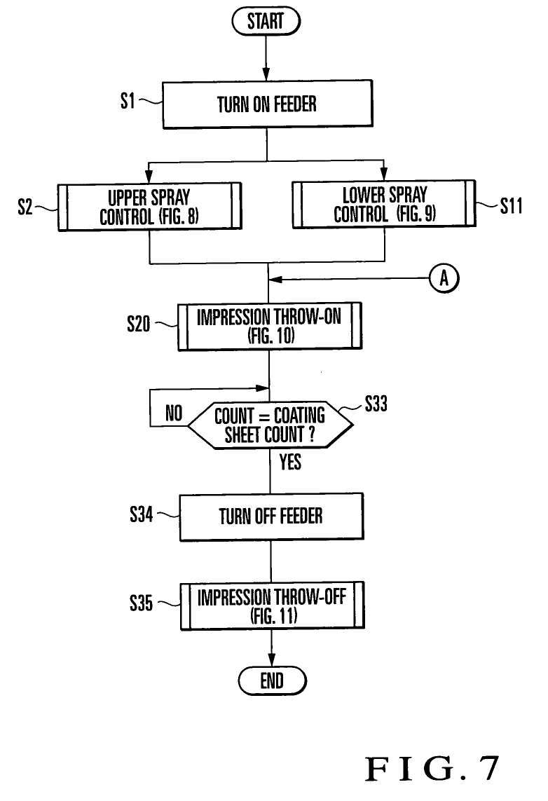

Two cylinder throw-on/off mechanisms which throw on/off the upper blanket cylinder 25 and lower plate cylinder 28 will be described with reference to FIG. 3. As these cylinder throw-on/off mechanisms have the same structure, only an upper blanket cylinder throw-on/off mechanism 33A which engages/releases the upper blanket cylinder 25 will be described in detail. A lower plate cylinder throw-on/off mechanism 33B (FIG. 7) which throws on/off the lower plate cylinder 28 will be briefly described where necessary.

A pair of frames 35 arranged to oppose each other at a predetermined gap rotatably, axially support the two end shafts of each of the blanket cylinder 26 and upper plate cylinder 21 through bearings (not shown). Eccentric bearings 36 fitted on the pair of frames 35 rotatably, axially support two end shafts 25b of the upper blanket cylinder 25. A stud 37 projecting outward from one frame 35 near one end shaft of the blanket cylinder 26 supports a bracket 38. A stepping motor 39 serving as a driving device is attached to the bracket 38 with a driving rod 40 standing vertically.

When a nut 39a is driven by the stepping motor 39 to rotate, the driving rod 40 with a threaded portion threadably engaging with the nut 39a vertically moves. A connecting lever 42 having an L shape when seen from the front is axially mounted on the projecting portion of a lever shaft 41 which is located above the driving rod 40 and the two ends of which are axially supported by the pair of frames 35.

Each eccentric bearing 36 has an outer ring (not shown) fitted with a housing mounted in the bearing hole of the corresponding frame 35 through a needle roller and an inner ring (not shown) rotatably fitted in the outer ring through a tapered roller. A bearing lever 43 fixed to the outer ring of the eccentric bearing 36 is connected to the connecting lever 42 through a rod 44. When the driving rod 40 is driven by the stepping motor 39 to move forward/backward, the eccentric bearing 36 pivots through the connecting lever 42, rod 44, and bearing lever 43.

The axis of the inner circumferential surface of the inner ring that constitutes the eccentric bearing 36 is eccentric from that of the outer circumferential surface of the outer ring that constitutes the eccentric bearing 36 by a predetermined distance. Accordingly, in the thrown-on state of the upper blanket cylinder 25, when the rod 40 of the stepping motor 39 moves backward, the axis of the inner circumferential surface of the inner ring moves about the axis of the outer circumferential surface of the outer ring as the center. Accordingly, the upper blanket cylinder 25 is spaced apart from the blanket cylinder 26 and upper plate cylinder 21 to form a gap between the two cylinders 21 and 26, thus performing impression throw-off.

The eccentric bearing (not shown) of the lower plate cylinder 28 is provided with a similar mechanism which is driven by a stepping motor (not shown) to pivot the eccentric bearing. Accordingly, regarding the lower plate cylinder 28 as well, when the eccentric bearing pivots upon rotation of the stepping motor, the lower plate cylinder 28 is spaced apart from the blanket cylinder 26 to form a gap with respect to the blanket cylinder 26, thus performing impression throw-off.

### [Anilox Roller Throw-On/Off Mechanism]

An upper anilox roller throw-on/off mechanism 45A which throws the anilox roller 23 which forms the varnish supply device 22 on/off the upper plate cylinder 21, and a lower anilox roller throw-on/off mechanism 45B which throws the anilox roller 30, forming the varnish supply device 29, on/off the lower plate cylinder 28 will be described with reference to FIG. 4. First, the upper anilox roller throw-on/off mechanism 45A will be described.

The anilox roller 23 is pivotally supported by the frames 35 through eccentric bearings 23a. The proximal end of a bearing lever 48A is fixed to the outer ring of the corresponding eccentric bearing 23a. The swing end of the bearing lever 48A is pivotally mounted on a rod 47A of an air cylinder 46A the cylinder end of which is pivotally mounted on the corresponding frame 35. In this arrangement, when the rod 47A of the air cylinder 46A moves forward/backward, the anilox roller 23 is thrown on/off the upper plate cylinder 21 through the bearing lever 48A.

The lower anilox roller throw-on/off mechanism 45B will be described. The anilox roller 30 is pivotally supported by the frames 35 through eccentric bearings 30a. The proximal end of a bearing lever 48B is fixed to the outer ring of the corresponding eccentric bearing 30a. The swing end of the bearing lever 48B is pivotally mounted on a rod 47B of an air cylinder 46B the cylinder end of which is pivotally mounted on the corresponding frame 35. In this arrangement, when the rod 47B of the air cylinder 46B moves forward/backward, the anilox roller 30 is thrown on/off the lower plate cylinder 28 through the bearing lever 48B.

As shown in FIG. 2, a cleaning apparatus 49 comprises a cleaning web which comes into contact with and separates from the circumferential surface of the upper blanket cylinder 25. The cleaning apparatus 49 wipes off varnish or contamination attached to the circumferential surface of the upper blanket cylinder 25 as the cleaning web comes into contact with the circumferential surface of the upper blanket cylinder 25.

### [Viscosity Reducing Agent Supply Means]

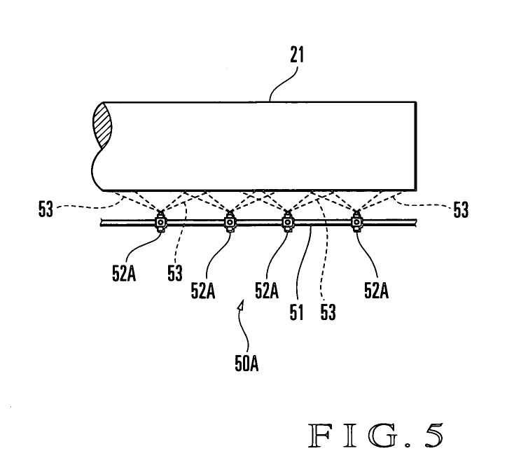

A first viscosity reducing agent supply device 50A which supplies a varnish viscosity reducing agent to the circumferential surface of the upper plate cylinder 21, and a second viscosity reducing agent supply device 50B which supplies the varnish viscosity reducing agent to the circumferential surface of the blanket cylinder 26 will be described with reference to FIGS. 2 and 5. As the two viscosity reducing agent supply devices 50A and 50B have the same structure, only the first viscosity reducing agent supply device 50A will be described, and the second viscosity reducing agent supply device 50B will be described where necessary.

As shown in FIG. 5, the first viscosity reducing agent supply device 50A comprises a pipe 51 horizontally extending between the pair of frames 35 such that its axial direction is parallel to that of the upper plate cylinder 21. The pipe 51 is provided with a plurality of lower sprays 52A to oppose each other throughout the entire axial direction of the upper plate cylinder 21. The upper sprays 52A selectively blow atomized water 53 serving as a varnish viscosity reducing agent to the circumferential surface of the upper plate cylinder 21.

The second viscosity reducing agent supply device 50B comprises a pipe horizontally extending between the pair of frames 35 such that its axial direction is parallel to that of the blanket cylinder 26. The pipe is provided with a plurality of lower sprays 52B to oppose each other throughout the entire axial direction of the blanket cylinder 26. The lower sprays 52B blow the atomized water 53 serving as the varnish viscosity reducing agent to the circumferential surface of the blanket cylinder 26.

### [Electrical Configuration]

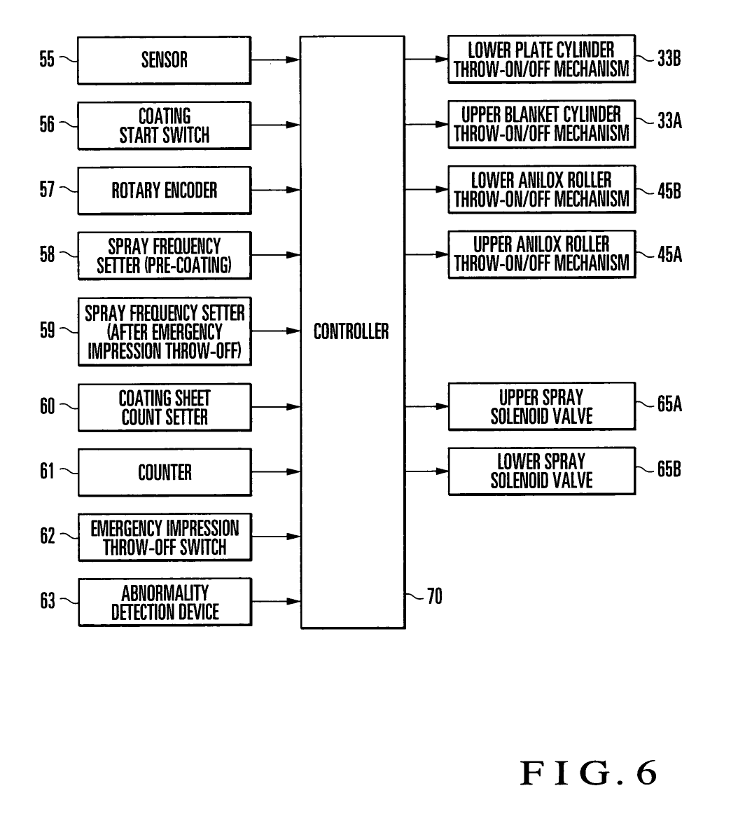

The electrical configuration of the present invention will be described with reference to FIG. 6. The liquid transfer apparatus according to the present invention comprises, in addition to the upper blanket cylinder throw-on/off mechanism 33A, lower plate cylinder throw-on/off mechanism 33B, upper anilox roller throw-on/off mechanism 45A, and lower anilox roller throw-on/off mechanism 45B described above, a sensor 55, a coating start switch 56, a rotary encoder 57, a pre-coating spray frequency setter 58, a post-emergency-throw-off spray frequency setter 59, a coating sheet count setter 60, a counter 61, an emergency impression throw-off switch 62, an abnormality detection device 63, an upper spray solenoid valve 65A, a lower spray solenoid valve 65B, and a controller 70 which is connected to the respective elements described above.

The sensor 55 (sheet supply detection means) detects that the feeder 2 has fed a sheet onto the feeder board 15. The coating start switch 56 instructs the coating unit 4 to start coating. The rotary encoder 57 (printing press phase detection means) detects the phase of the printing press. The spray frequencies of the upper sprays 52A and lower sprays 52B before coating are set (input) in the spray frequency setter 58 (pre-coating spray frequency setting means). By setting the spray frequencies, the amounts of varnish viscosity reducing agent 53 to be supplied from the upper sprays 52A and lower sprays 52B, respectively, are set.

The spray frequencies of the upper sprays 52A and lower sprays 52B, respectively, after emergency impression throw-off are set (input) in the spray frequency setter 59 (post-coating spray frequency setting means). By setting the spray frequencies, the amounts of varnish viscosity reducing agent 53 to be supplied from the upper sprays 52A and 52B, respectively, are set. The number of sheets to be coated by the coating unit 4 is set (input) in the coating sheet count setter 60 (coating sheet count setting means). The counter 61 counts the number of sheets coated by the coating unit 4. Each of the spray frequency setters 58 and 59 and coating sheet count setter 60 comprises a ten-key input device to which the operator inputs desired data. Alternatively, the operator may select an input mode from one ten-key input device, e.g., a personal computer, which has a plurality of input modes corresponding to the types of data, and input a necessary type of data. If the value of the data is fixed and only the fixed data need be read out, a memory may be used.

When some abnormality occurs in the printing press, the operator manipulates the emergency impression throw-off switch 62 to instruct impression throw-off. The abnormality detection device 63 (abnormality detection means) detects an abnormality occurring in the printing press or a sheet abnormality (curling, double feed, or the like) automatically. The printing press abnormality and the sheet abnormality may be detected by separate abnormality detection devices. When the emergency impression throw-off switch 62 is manipulated, the controller 70 controls the upper blanket cylinder throw-on/off mechanism 33A, lower plate cylinder throw-on/off mechanism 33B, upper anilox roller throw-on/off mechanism 45A, and lower anilox roller throw-on/off mechanism 45B to perform emergency impression throw-off. The controller 70 also emergently stops the apparatus when the abnormality detection device 63 detects an apparatus abnormality. The upper spray solenoid valve 65A is opened when discharging the liquid from the upper sprays 52A. The lower spray solenoid valve 65B is opened when discharging the liquid from the lower sprays 52B.

The controller 70 controls the opening/closing operation of the upper spray solenoid valve 65A and lower spray solenoid valve 65B until the injection frequencies of the upper sprays 52A and lower sprays 52B reach the spray injection frequencies set in the spray frequency setter 58. The controller 70 controls the opening/closing operation of the upper spray solenoid valve 65A and lower spray solenoid valve 65B until the injection frequencies of the upper sprays 52A and lower sprays 52B reach the spray injection frequencies set in the spray frequency setter 59.

While the upper sprays 52A blow the varnish viscosity reducing agent 53 to the circumferential surface of the upper plate cylinder 21, when the rotary encoder 57 detects the phase of the cleaning liquid blowing range of the upper sprays 52A corresponding to the notch 21a of the upper plate cylinder 21, the controller 70 closes the upper spray solenoid valve 65A to stop blowing the varnish viscosity reducing agent 53 from the upper sprays 52A. Similarly, while the lower sprays 52B blow the varnish viscosity reducing agent 53 to the circumferential surface of the upper plate cylinder 21, when the rotary encoder 57 detects the phase of the cleaning liquid blowing range of the lower sprays 52B corresponding to the notch 26a of the blanket cylinder 26, the controller 70 closes the lower spray solenoid valve 65B to stop blowing the varnish viscosity reducing agent 53 from the lower sprays 52B.

When the counter 61 counts the coating sheet count set by the coating sheet count setter 60, the controller 70 stops the coating operation, that is, the feed operation of the feeder 2. In throw-on of the upper blanket cylinder 25, when the notch 25a of the upper blanket cylinder 25 opposes the notch 21a of the upper plate cylinder 21, the controller 70 throws the upper blanket cylinder 25 on the upper plate cylinder 21 on the basis of the phase of the upper blanket cylinder 25 detected by the rotary encoder 57. Then, when the notch 25a of the upper blanket cylinder 25 opposes the notch 26a of the blanket cylinder 26, the controller 70 throws the upper blanket cylinder 25 on the blanket cylinder 26.

In throw-on of the lower plate cylinder 28, when the notch 28a of the lower plate cylinder 28 opposes the notch 26a of the blanket cylinder 26, the controller 70 throws the lower plate cylinder 28 on the blanket cylinder 26 on the basis of the phase of the lower plate cylinder 28 detected by the rotary encoder 57.

In throw-off of the upper blanket cylinder 25, when the notch 25a of the upper blanket cylinder 25 opposes the notch 21a of the upper plate cylinder 21, the controller 70 throws the upper blanket cylinder 25 off the upper plate cylinder 21 on the basis of the phase of the upper blanket cylinder 25 detected by the rotary encoder 57. Then, when the notch 25a of the upper blanket cylinder 25 opposes the notch 26a of the blanket cylinder 26 the controller 70 throws the upper blanket cylinder 25 off the blanket cylinder 26.

Also, in throw-off of the lower plate cylinder 28, when the notch 28a of the lower plate cylinder 28 opposes the notch 26a of the blanket cylinder 26, the controller 70 throws the lower plate cylinder 28 off the blanket cylinder 26 on the basis of the phase of the lower plate cylinder 28 detected by the rotary encoder 57.

### [Coating Operation]

The coating operation of the coating apparatus having the above apparatus will be described with reference to FIGS. 7 to 15. First, normal coating operation will be described with reference to FIGS. 7 to 11.

### [Normal Coating]

When the coating start switch 56 is manipulated, the feeder 2 starts feeding the sheet onto the feeder board 15 (step S1 in FIG. 7).

### [Upper Spray Control (Pre-Coating)]

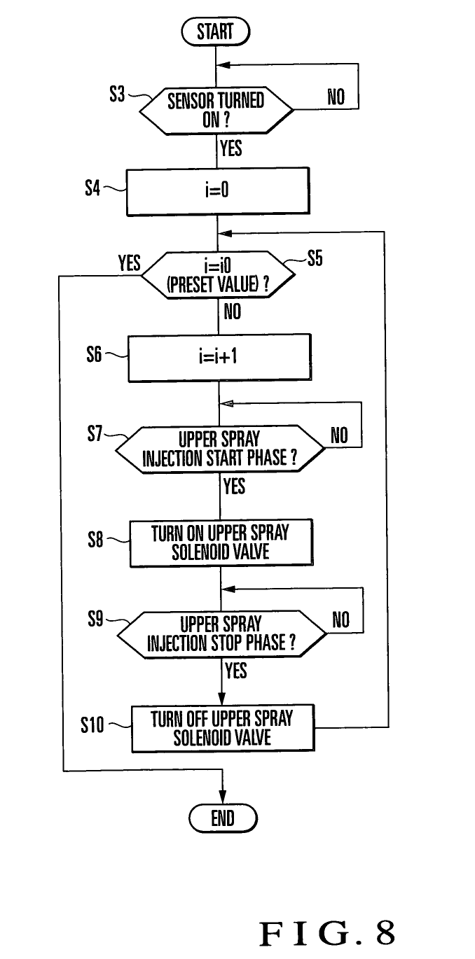

The controller 70 then actuates the upper sprays 52A of the first viscosity reducing agent supply device 50A (step S2). FIG. 8 shows step S2 in detail. First, if the sensor 55 which detects the presence/absence of the sheet on the feeder board 15 is not turned on, that is, if the sheet has not arrived at a predetermined position on the feeder board 15, the process waits its arrival (NO in step S3). If the sensor 55 is turned on (YES in step S3), that is, if the sheet has arrived at the predetermined position on the feeder board 15 and the sensor 55 detects this sheet, the injection frequency “i” of the upper sprays 52A is set to satisfy i=0 (step S4).

If “i” is not equal to the value “i0” set by the spray frequency setter 58 (NO in step S5), “i” is incremented by “1” (step S6). If the phase detected by the rotary encoder 57 is not the upper spray injection start phase (NO in step S7), that is, if the injection range of the upper sprays 52A includes the notch 21a of the upper plate cylinder 21, the process waits until the phase of the upper plate cylinder 21 falls outside the injection range.

If the phase detected by the rotary encoder 57 is the upper spray injection start phase (YES in step S7), that is, if the notch 21a of the upper plate cylinder 21 passes the injection range of the upper sprays 52A and the injection range of the upper sprays 52A starts to include the effective surface of the upper plate cylinder 21, the upper spray solenoid valve 65A is turned on. Thus, the upper sprays 52A blow the atomized varnish viscosity reducing agent 53 uniformly to the entire circumferential surface of the upper plate cylinder 21. Then, if the detected phase is not the upper spray injection stop phase (NO in step S9), that is, if the injection range of the upper sprays 52A does not include the notch 21a of the upper plate cylinder 21, the injection operation is continued.

If the detected phase is the upper spray injection stop phase (YES in step S9), that is, if the injection range of the upper sprays 52A starts to include the phase of the notch 21a of the upper plate cylinder 21, the upper spray solenoid valve 65A is turned off (step S10). Thus, injection by the upper sprays 52A is stopped, and the process returns to step S5. If i≠i0 (NO in step S5), the operation of steps S5 to S10 described above is repeated. If i=i0 (YES in step S5), supply of the varnish viscosity reducing agent 53 from the upper sprays 52A is ended. Thus, the varnish viscosity reducing agent 53 will not be blown from the upper sprays 52A into the notch 21a of the upper plate cylinder 21.

### [Lower Spray Control (Pre-Coating)]

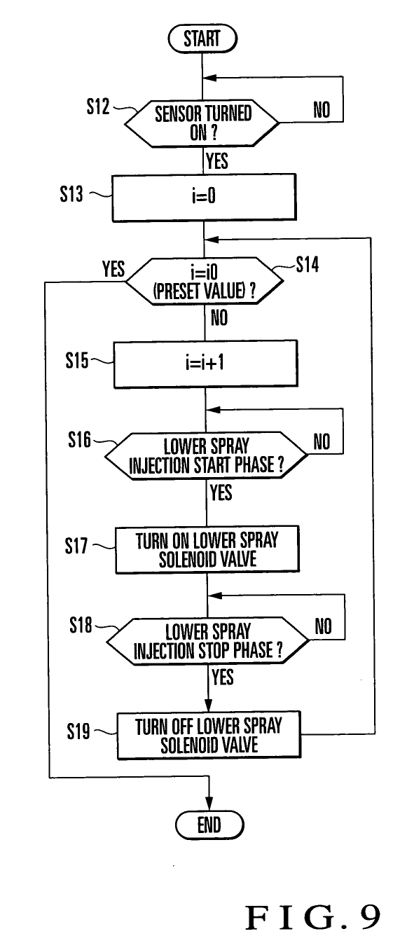

Referring back to FIG. 7, as well as the lower sprays 52B of the second viscosity reducing agent supply device 50B, the controller 70 also actuates the upper sprays 52A of the first viscosity reducing agent supply device 50A simultaneously (step S11). FIG. 9 shows step S11 in detail. First, if the sensor 55 which detects the presence/absence of the sheet on the feeder board 15 is not turned on, that is, if the sheet has not arrived at the predetermined position on the feeder board 15, the process waits its arrival (step S12). If the sensor 55 is turned on (YES in step S12), that is, if the sheet has arrived at the predetermined position on the feeder board 15 and the sensor 55 detects this sheet, the injection frequency “i” of the lower sprays 52B is set to satisfy i=0 (step S13).

If “i” is not equal to the value “i0” set by the spray frequency setter 58 (NO in step S14), “i” is incremented by “1”. If the phase detected by the rotary encoder 57 is not the lower spray injection start phase (NO in step S16), that is, if the injection range of the lower sprays 52B includes the notch 26a of the blanket cylinder 26, the process waits until the phase of the notch 26a falls outside the injection range.

If the phase detected by the rotary encoder 57 is the lower spray injection start phase (YES in step S16), that is, if the notch 26a of the blanket cylinder 26 passes the injection range of the lower sprays 52B and the injection range of the lower sprays 52B starts to include the effective surface of the blanket cylinder 26, the lower spray solenoid valve 65B is turned on (step S17). Thus, the lower sprays 52B blow the atomized varnish viscosity reducing agent 53 to the circumferential surface of the blanket cylinder 26. Then, if the detected phase is not the lower spray injection stop phase (NO in step S18), that is, if the injection range of the lower sprays 52B does not include the notch 26a of the blanket cylinder 26, the injection operation is continued.

If the detected phase is the lower spray stop phase (YES in step S18), that is, if the injection range of the lower sprays 52B starts to include the phase of the notch 26a of the blanket cylinder 26, the lower spray solenoid valve 65B is turned off (step S19). Thus, injection by the lower sprays 52B is stopped, and the process returns to step S14. If i≠i0 (NO in step S14), the operation of steps S14 to S19 is repeated. If i=0 (YES in step S14), supply of the varnish viscosity reducing agent 53 from the lower sprays 52B is ended. Thus, the varnish viscosity reducing agent 53 will not be blown from the lower sprays 52B into the notch 26a of the blanket cylinder 26.

### [Impression Throw-On]

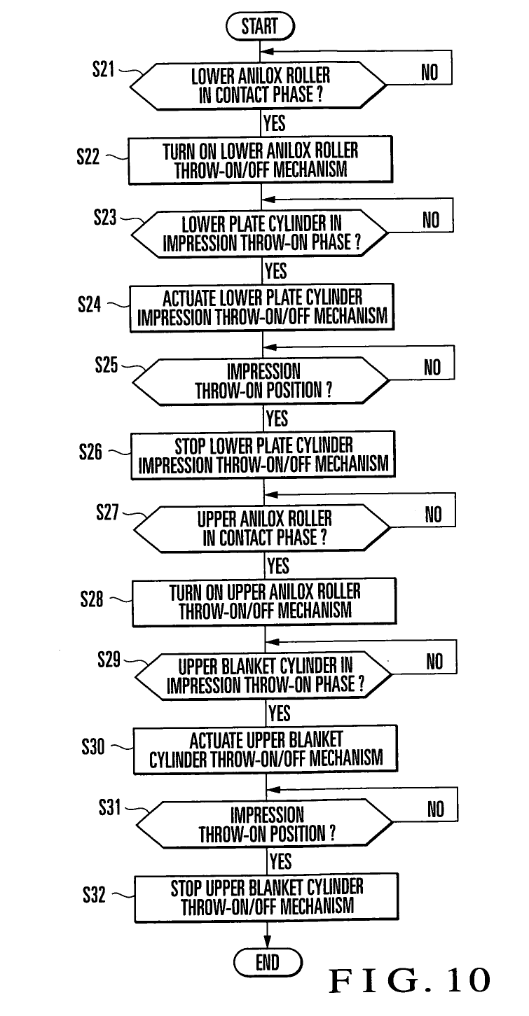

Referring back to FIG. 7, when the process of steps S2 and Sll is ended, the controller 70 performs impression throw-on (step S20). FIG. 10 shows step S20 in detail. First, if the lower anilox roller 30 is not in the contact phase with respect to the lower plate cylinder 28 (NO in step S21), that is, if the lower anilox roller 30 does not oppose the notch 28a of the lower plate cylinder 28, the process waits until the lower anilox roller 30 does. If the lower anilox roller 30 is in the contact phase (YES in step S21), that is, if the lower anilox roller 30 opposes the notch 28a of the lower plate cylinder 28, the lower anilox roller throw-on/off mechanism 45B is turned on (step S22). Thus, the lower anilox roller 30 comes into contact with the lower plate cylinder 28.

If the lower plate cylinder 28 is not in the impression throw-on phase with respect to the lower plate cylinder 28 (NO in step S23), that is, if the notch 28a of the lower plate cylinder 28 does not oppose the notch 26a of the blanket cylinder 26, the process waits until the notch 28a does. If the lower plate cylinder 28 is in the impression throw-on phase with respect to the blanket cylinder 26 (YES in step S23), that is, if the notch 28a of the lower plate cylinder 28 opposes the notch 26a of the blanket cylinder 26, the lower plate cylinder throw-on/off mechanism 33B is actuated (step S24). Thus, the lower plate cylinder 28 moves in a direction to be close to the blanket cylinder 26.

Then, if the lower plate cylinder 28 is not at a predetermined impression throw-on position with respect to the blanket cylinder 26 (NO in step S25), the process waits until the lower plate cylinder 28 is. If the lower plate cylinder 28 is at the predetermined impression throw-on position with respect to the blanket cylinder 26 (YES in step S25), the actuation of the lower plate cylinder throw-on/off mechanism 33B is stopped (step S26). Thus, the lower plate cylinder 28 opposes the blanket cylinder 26.

Then, if the upper anilox roller 23 is not in the contact phase with respect to the upper plate cylinder 21 (NO in step S27), that is, if the upper anilox roller 23 does not oppose the notch 21a of the upper plate cylinder 21, the process waits until the upper anilox roller 23 does. If the upper anilox roller 23 is in the contact phase with respect to the upper plate cylinder 21 (YES in step S27), that is, if the upper anilox roller 23 opposes the notch 21a of the upper plate cylinder 21, the upper anilox roller throw-on/off mechanism 45A is turned on (step S28). Thus, the upper anilox roller 23 comes into contact with the upper plate cylinder 21.

If the upper blanket cylinder 25 is not in the impression throw-on phase with respect to the upper plate cylinder 21 and blanket cylinder 26 (NO in step S29), that is, if the notch 25a of the upper blanket cylinder 25 opposes neither the notch 21a of the upper plate cylinder 21 nor the notch 26a of the blanket cylinder 26, the process waits until the notch 25a does. If the upper blanket cylinder 25 is in the impression throw-on phase with respect to the upper plate cylinder 21 and blanket cylinder 26 (YES in step S29), that is, if the notch 25a of the upper blanket cylinder 25 opposes the notch 21a of the upper plate cylinder 21 and thereafter the notch 25a of the upper blanket cylinder 25 opposes the notch 26a of the blanket cylinder 26, the upper blanket cylinder throw-on/off mechanism 33A is actuated (step S30). Thus, the upper blanket cylinder 25 moves in a direction to be close to the upper plate cylinder 21 and blanket cylinder 26.

Then, if the upper blanket cylinder 25 is at a predetermined impression throw-on position with respect to neither the upper plate cylinder 21 nor the blanket cylinder 26 (NO in step S31), the process waits until the upper blanket cylinder 25 is. If the upper blanket cylinder 25 is at the predetermined impression throw-on position with respect to the upper plate cylinder 21 and blanket cylinder 26 (YES in step S31), the actuation of the upper blanket cylinder throw-on/off mechanism 33A is stopped (step S32). Thus, the upper blanket cylinder 25 comes into contact with the upper plate cylinder 21 to urge the sheet against the blanket cylinder 26.

Immediately after the coating operation is started, the varnish supplied from the upper anilox roller 23 to the upper plate cylinder 21 is not sufficient and thus tends to dry. In steps S5 to S10 described above, the varnish viscosity reducing agent 53 supplied from the upper sprays 52A to the circumferential surface of the upper plate cylinder 21 prevents the varnish on the circumferential surface of the upper plate cylinder 21 from increasing in viscosity or drying. Therefore, the varnish does not increase in viscosity or dry also on the circumferential surface of the upper blanket cylinder 25 which is thrown on the upper plate cylinder 21.

In steps S14 to S19 described above, the varnish viscosity reducing agent 53 supplied from the lower sprays 52B to the circumferential surface of the blanket cylinder 26 transfers to the lower plate cylinder 28 which is thrown on the blanket cylinder 26. Hence, in the same manner as the upper blanket cylinder 25, immediately after the coating operation is started, the varnish supplied from the lower anilox roller 30 to the lower plate cylinder 28 is insufficient and thus tends to dry. In this case, the varnish viscosity reducing agent 53 transferring to the lower plate cylinder 28 prevents the varnish on the circumferential surface of the lower plate cylinder 28 from increasing in viscosity or drying. Therefore, the varnish does not increase in viscosity or dry also on the circumferential surface of the blanket cylinder 26 which is in contact with the lower plate cylinder 28.

After sheet feed starts in step S1, impression throw-on takes place in step S20 immediately before the cylinders are coated by the coating unit 4. During impression throw-on, the varnish on the circumferential surfaces of the upper blanket cylinder 25 and blanket cylinder 26 does not increase in viscosity or dry, as described above. Thus, the two surfaces of the paper passing between the upper blanket cylinder 25 and blanket cylinder 26 are coated without sticking to the circumferential surfaces of the two cylinders 25 and 26.

Referring back to FIG. 7, in step S33, the controller 70 compares the coating sheet count set by the coating sheet count setter 60 with that counted by the counter 61 (step S33). If the count of the counter 61 is different from the coating sheet count, the process waits until they are equal. When the coating sheet count set by the coating sheet count setter 60 becomes equal to that counted by the counter 61, the controller 70 turns off the feeder 2 to stop feeding from it (step S34).

### [Impression Throw-Off]

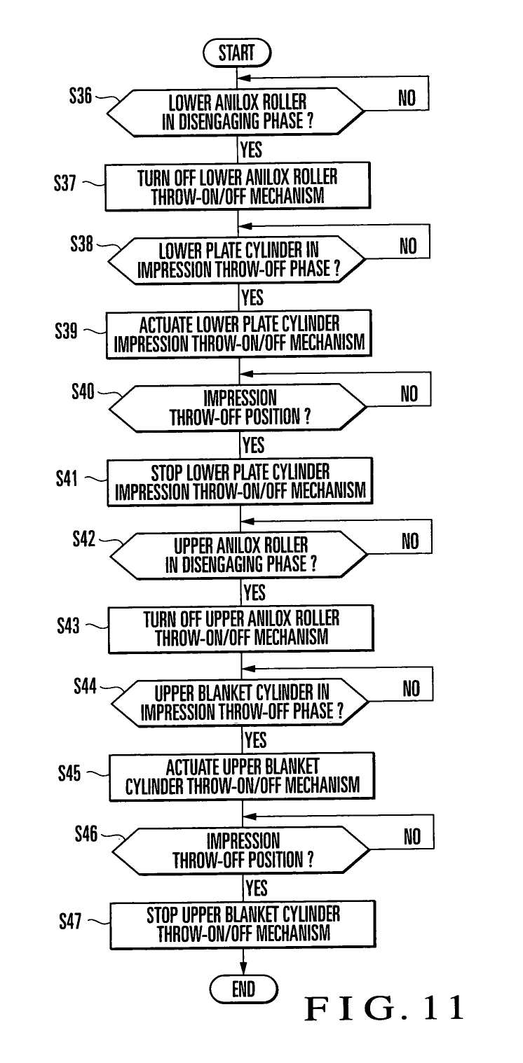

Then, the controller 70 performs impression throw-off (step S35). FIG. 11 shows step S35 in detail. First, if the lower anilox roller 30 is not in the disengaging phase with respect to the lower plate cylinder 28 (NO in step S36), that is, if the lower anilox roller 30 does not oppose the notch 28a of the lower plate cylinder 28, the process waits until the lower anilox roller 30 does. If the lower anilox roller 30 is in the disengaging phase (YES in step S36), that is, if the lower anilox roller 30 opposes the notch 28a of the lower plate cylinder 28, the lower anilox roller throw-on/off mechanism 45B is turned off (step S37). Thus, the lower anilox roller 30 separates from the lower plate cylinder 28.

If the lower plate cylinder 28 is not in the impression throw-off phase with respect to the blanket cylinder 26 (NO in step S38), that is, if the notch 28a of the lower plate cylinder 28 does not oppose the notch 26a of the blanket cylinder 26, the process waits until the notch 28a does. If the lower plate cylinder 28 is in the impression throw-off phase with respect to the blanket cylinder 26 (YES in step S38), that is, if the notch 28a of the lower plate cylinder 28 opposes the notch 26a of the blanket cylinder 26, the lower plate cylinder throw-on/off mechanism 33B is actuated (step S39). Thus, the lower plate cylinder 28 moves in a direction to separate from the blanket cylinder 26.

Then, if the lower plate cylinder 28 is not at the predetermined impression throw-off position with respect to the blanket cylinder 26 (NO in step S40), the process waits until the lower plate cylinder 28 is. If the lower plate cylinder 28 is at the predetermined impression throw-off position with respect to the blanket cylinder 26 (YES in step S40), the actuation of the lower plate cylinder throw-on/off mechanism 33B is stopped (step S41). Thus, the lower plate cylinder 28 separates from the blanket cylinder 26.

Then, if the upper anilox roller 23 is not in the disengaging phase with respect to the upper plate cylinder 21 (NO in step S42), that is, if the upper anilox roller 23 does not oppose the notch 21a of the upper plate cylinder 21, the process waits until the upper anilox roller 23 does. If the upper anilox roller 23 is in the disengaging phase with respect to the upper plate cylinder 21 (YES in step S42), that is, if the upper anilox roller 23 opposes the notch 21a of the upper plate cylinder 21, the upper anilox roller throw-on/off mechanism 45A is turned off (step S43). Thus, the upper anilox roller 23 separates from the upper plate cylinder 21.

If the upper blanket cylinder 25 is not in the impression throw-off phase with respect to the upper plate cylinder 21 and blanket cylinder 26 (NO in step S44), that is, if the notch 25a of the upper blanket cylinder 25 does not oppose the notch 21a of the upper plate cylinder 21 nor the notch 26a of the blanket cylinder 26, the process waits until the notch 25a does. If the upper blanket cylinder 25 is in the impression throw-off phase with respect to the upper plate cylinder 21 and blanket cylinder 26 (YES in step S44), that is, if the notch 25a of the upper blanket cylinder 25 opposes the notch 21a of the upper plate cylinder 21 and thereafter opposes the notch 26a of the blanket cylinder 26, the upper blanket cylinder throw-on/off mechanism 33A is actuated (step S45). Thus, the upper blanket cylinder 25 moves in a direction to separate from the blanket cylinder 26 and upper plate cylinder 21.

Then, if the upper blanket cylinder 25 is not at the predetermined impression throw-off position with respect to the upper plate cylinder 21 nor the blanket cylinder 26 (NO in step S46), the process waits until the upper blanket cylinder 25 is. If the upper blanket cylinder 25 is at the predetermined impression throw-off position with respect to the upper plate cylinder 21 and blanket cylinder 26 (YES in step S46), the actuation of the upper blanket cylinder throw-on/off mechanism 33A is stopped (step S47). Thus, the upper blanket cylinder 25 separates from the upper plate cylinder 21 and blanket cylinder 26.

Coating operation during emergency stop will be described with reference to FIG. 7 and FIGS. 12 to 15.

### [Emergency Impression Throw-Off]

The controller 70 checks whether an emergency impression throw-off signal is output (step S48). The emergency impression throw-off signal is generated when the abnormality detection device 63 outputs an abnormality signal or the emergency impression throw-off switch 62 is turned on manually. If the emergency impression throw-off signal is output (YES in step S48), the controller 70 turns off the upper anilox roller throw-on/off mechanism 45A and lower anilox roller throw-on/off mechanism 45B (step S49). Thus, the upper anilox roller 23 separates from the upper plate cylinder 21 and the lower anilox roller 30 separates from the lower plate cylinder 28.

The controller 70 actuates the lower plate cylinder throw-on/off mechanism 33B almost simultaneously with step S49 (step S50). If the lower plate cylinder 28 is not at the predetermined impression throw-off position with respect to the blanket cylinder 26 (NO in step S51), the process waits until the lower plate cylinder 28 is. If the lower plate cylinder 28 is at the predetermined impression throw-off position with respect to the blanket cylinder 26 (YES in step S51), the controller 70 stops actuation of the lower plate cylinder throw-on/off mechanism 33B (step S52).

The controller 70 actuates the upper blanket cylinder throw-on/off mechanism 33A almost simultaneously with steps S48 and S50 (step S53). Then, if the upper blanket cylinder 25 is not at the predetermined impression throw-off position with respect to the upper plate cylinder 21 and blanket cylinder 26 (NO in step S54), the process waits until the upper blanket cylinder 25 is. If the upper blanket cylinder 25 is at the predetermined impression throw-off position with respect to the upper plate cylinder 21 and blanket cylinder 26 (YES in step S54), the controller 70 stops actuation of the upper blanket cylinder throw-on/off mechanism 33A (step S55). Thus, in the case of emergency impression throw-off, impression throw-off takes place regardless of the phase of the printing press.

### [Coating Resumption]

When the coating start switch 56 is manipulated and the feeder 2 is turned on (YES in step S56), the feeder 2 resumes sheet feed, and the controller 70 performs post-emergency-impression-throw-off upper spray control and lower spray control (steps S57, S65). As described above, after the printing press is emergently stopped, when the feeder 2 resumes sheet feed, the varnish remains on the circumferential surface of each of the upper blanket cylinder 25 and blanket cylinder 26 in an amount sufficient for coating, unlike immediately after the start of coating. The varnish remaining on the circumferential surface gradually dries and its viscosity increases.

### [Upper Spray Control (After Emergency Impression Throw-Off)]

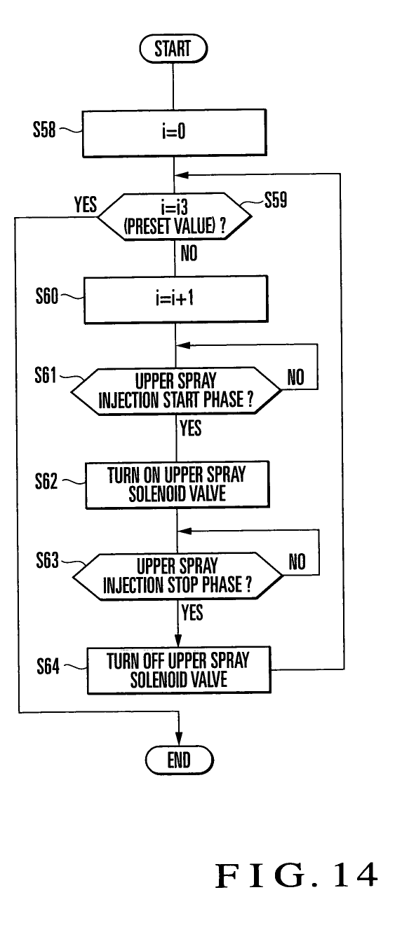

FIG. 14 shows step S57 in detail. First, the injection frequency “i” of the upper sprays 52A is set to satisfy i=0 (step S58). If “i” is not equal to the value “i3” set by the post-emergency-impression-throw-off spray frequency setter 59 (NO in step S59), “i” is incremented by “1” (step S60). The value “i3” set by the post-emergency-impression-throw-off spray frequency setter 59 is arbitrarily set by the operator in accordance with the type of varnish, coating specifications, and the like. If the phase detected by the rotary encoder 57 is not the upper spray injection start phase (NO in step S61), that is, if the injection range of the upper sprays 52A does not include the notch 21a of the upper plate cylinder 21, the process waits until the injection range does.

If the phase detected by the rotary encoder 57 is the upper spray injection start phase (YES in step S61), that is, if the notch 21a of the upper plate cylinder 21 passes the injection range of the upper sprays 52A and the injection range of the upper sprays 52A starts to include the effective surface of the upper plate cylinder 21, the upper spray solenoid valve 65A is turned on (step S62). Thus, the upper sprays 52A blow the atomized varnish viscosity reducing agent 53 to the circumferential surface of the upper plate cylinder 21.

If the detected phase is not the upper spray injection stop phase, that is, if the injection range of the upper sprays 52A does not include the notch 21a of the upper plate cylinder 21 (NO in step S63), the injection operation is continued.

If the detected phase is the upper spray injection stop phase (YES in step S63), that is, if the injection range of the upper sprays 52A starts to include the notch 21a of the upper plate cylinder 21, the upper spray solenoid valve 65A is turned off (step S64). Thus, injection by the upper sprays 52A is stopped, and the process returns to step S59. If i≠i3 (NO in step S59), the operation of steps S59 to S64 is repeated. If i=i3 (YES in step S59), supply of the varnish viscosity reducing agent 53 from the upper sprays 52A is ended. Thus, the varnish viscosity reducing agent 53 will not be blown from the upper sprays 52A into the notch 21a of the upper plate cylinder 21.

In steps S59 to S65 described above, the varnish viscosity reducing agent 53 which is supplied from the upper sprays 52A to the circumferential surface of the upper plate cylinder 21 initially covers the surface of the varnish that has been gradually dried after emergency stop to increase in viscosity. This quickly decreases the adhesive force of the varnish surface. After that, the varnish viscosity reducing agent 53 on the varnish surface penetrates into the varnish to decrease its viscosity. Thus, both the tackiness and adhesive force of the varnish decrease.

### [Lower Spray Control (After Emergency Throw-Off)]

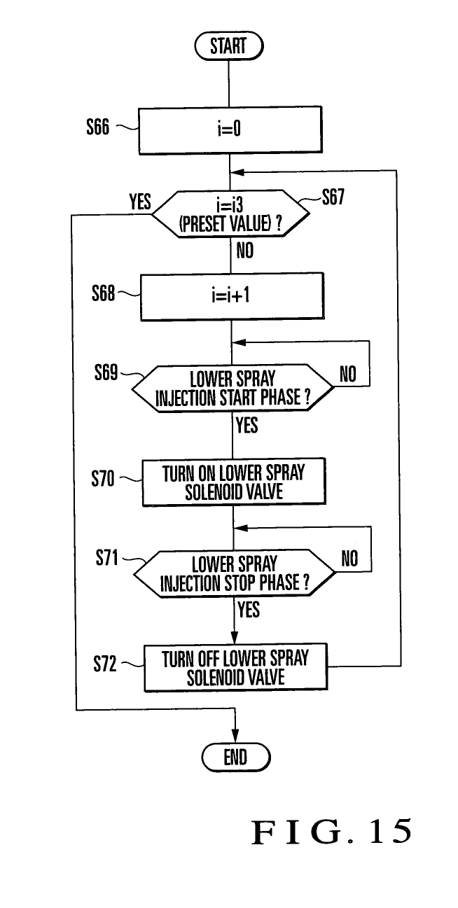

FIG. 15 shows step S65 in detail. First, the injection frequency “i” of the lower sprays 52B is set to satisfy i=0 (step S66). If “i” is not equal to the value “i3” set by the post-emergency-throw-off spray frequency setter 59 (NO in step S67), “i” is incremented by “1”. Then, if the phase detected by the rotary encoder 57 is not the lower spray injection start phase (NO in step S69), that is, if the injection range of the lower sprays 52B includes the notch 26a of the blanket cylinder 26, the process waits until the injection range includes the notch 26a.

If the phase detected by the rotary encoder 57 is the lower spray injection start phase (YES in step S69), that is, if the notch 26a of the blanket cylinder 26 passes the injection range of the lower sprays 52B and the injection range of the lower sprays 52B starts to include the effective surface of the blanket cylinder 26, the lower spray solenoid valve 65B is turned on (step S70). Thus, the lower sprays 52B blow the atomized varnish viscosity reducing agent 53 to the circumferential surface of the blanket cylinder 26. Then, if the detected phase is not the lower spray injection stop phase (NO in step S71), that is, if the injection range of the lower sprays 52B does not include the notch 26a of the blanket cylinder 26, the injection operation is continued.

If the detected phase is the lower spray injection stop phase (YES in step S71), that is, if the injection range of the lower sprays 52B starts to include the notch 26a of the blanket cylinder 26, the lower spray solenoid valve 65B is turned on (step S72). Thus, injection by the lower sprays 52B is stopped, and the process returns to step S67. If i≠i3 (NO in step S67), the operation of steps S67 to S72 is repeated. If i=i3 (YES in step S67), supply of the varnish viscosity reducing agent 53 from the lower sprays 52B is stopped. Thus, the varnish viscosity reducing agent 53 will not be blown from the lower sprays 52B into the notch 26a of the blanket cylinder 26.

In this manner, the spray operation of the upper and lower sprays 52A and 52B includes repetition of spray injection by the upper and lower sprays 52A and 52B to the effective surface of the upper plate cylinder 21 or blanket cylinder 26 and stop of injection to the notch 21a or 26a. Accordingly, if the cylinder is a single cylinder having a single notch, the rotation frequency of the single cylinder is directly equivalent to the spray frequency. Although the supply amount of the varnish viscosity reducing agent 53 is set by the spray frequency in this embodiment, it may be set by increasing or decreasing the spray time or spray amount.

In steps S66 to S72 described above, at first, the varnish viscosity reducing agent 53 supplied from the lower sprays 52B to the circumferential surface of the blanket cylinder 26 covers the surface of the varnish that has been gradually dried after emergency stop to increase in viscosity, so that the adhesive force of the varnish decreases rapidly. After that, the varnish viscosity reducing agent 53 on the varnish surface penetrates into the varnish to decrease its viscosity. Thus, both the tackiness and adhesive force of the varnish increase.

In supply of the varnish viscosity reducing agent 53 by the upper and lower sprays 52A and 52B in steps S58 to S64 and S67 to S73, control operation takes place not to supply the varnish viscosity reducing agent 53 to the notch 21a of the upper plate cylinder 21 and the notch 26a of the blanket cylinder 26 each of which is provided with a gripper or the like. This prevents waste of the varnish viscosity reducing agent 53 and contamination or rusting of the rollers, thus improving the durability of the apparatus.

[Impression Throw-On after Emergency Impression Throw-Off]

When the process of steps S57 and S65 is ended, the process returns to FIG. 7 to perform impression throw-on (step S20). The details of step S32 have already been described with reference to FIG. 10, and a repetitive description will be omitted.

In the impression throw-on of the upper blanket cylinder 25 in steps S29 to S32 shown in FIG. 10, the upper blanket cylinder 25 is thrown on the upper plate cylinder 21 at the timing when the notch 21a of the upper plate cylinder 21 opposes the notch 25a of the upper blanket cylinder 25. Subsequently, the upper blanket cylinder 25 is thrown on the blanket cylinder 26 at the timing when the notch 25a of the upper blanket cylinder 25 opposes the notch 26a of the blanket cylinder 26. In this case, the upper blanket cylinder 25 comes into contact with the blanket cylinder 26 after coming into contact with the upper plate cylinder 21 and before completing rotation by one revolution. However, as the varnish viscosity reducing agent 53 has transferred from the upper plate cylinder 21 to that portion of the upper blanket cylinder 25 which presses the sheet and the varnish viscosity reducing agent 53 covers the varnish surface, the sheet will not stick to the upper blanket cylinder 25.

In this manner, if the varnish viscosity reducing agent 53 is supplied to the upper blanket cylinder 25 not directly but through the upper plate cylinder 21 indirectly, the sheet can be prevented from sticking to the upper blanket cylinder 25. In this embodiment, the upper blanket cylinder 25 comes into contact with the blanket cylinder 26 after coming into contact with the upper plate cylinder 21 and before completing rotation through one revolution. Alternatively, the upper blanket cylinder 25 may come into contact with the blanket cylinder 26 after coming into contact with the upper plate cylinder 21 and rotating through several revolutions.

The varnish viscosity reducing agent 53 may be supplied from the upper sprays 52A to the upper blanket cylinder 25 directly. In this case, the upper sprays 52A may be swingably supported to selectively oppose the upper plate cylinder 21 and upper blanket cylinder 25, so that the varnish viscosity reducing agent 53 injected by the upper sprays 52A is selectively blown to the upper plate cylinder 21 and upper blanket cylinder 25.

In this manner, after the printing press stops emergently, the varnish viscosity reducing agent 53 is supplied to the circumferential surfaces of the upper blanket cylinder 25 and blanket cylinder 26 before impression throw-on takes place to perform coating. Therefore, the viscosity of the varnish remaining on the circumferential surfaces of the upper blanket cylinder 25 and blanket cylinder 26 does not increase. This prevents the sheet from sticking to the circumferential surfaces of the upper blanket cylinder 25 and blanket cylinder 26 when the printing operation is resumed. As a result, the operation of removing the sheet from the varnish supply cylinder becomes unnecessary, reducing the work load to the operator and improving the productivity.

Returning to FIG. 7, impression throw-on (step S20) is performed upon coating resumption in FIG. 13, and after that the coating sheet count set by the coating sheet count setter 60 is compared with that counted by the counter 61 (step S33). When the coating sheet count set by the coating sheet count setter 60 becomes equal to that counted by the counter 61, the feeder is turned off (step S34). Hence, sheet feed from the feeder 2 is stopped.

[Impression Throw-Off after Emergency Impression Throw-Off]

Subsequent to step S34, the controller 70 performs impression throw-off (step S35). The details of step S35 have already been described with reference to FIG. 11 and a repetitive description will be omitted.

In this embodiment, the second viscosity reducing agent supply device 50B supplies the varnish viscosity reducing agent 53 to the blanket cylinder 26 directly. Alternatively, the varnish viscosity reducing agent 53 may be supplied to the lower plate cylinder 28, so it is supplied indirectly through the lower plate cylinder 28. In this embodiment, the present invention is applied to a coating apparatus. Alternatively, the present invention is applied to a printing apparatus which prints a sheet with ink. In this case, as the ink supply means, a chamber type inking device which supplies ink having a comparatively high viscosity from a chamber coater 24 or 31, or an inking device which is conventionally known well and has an ink fountain and a large number of rollers may be employed.

In the above embodiment, the target to which the varnish or ink is to be transferred is exemplified by a sheet. Alternatively, the target may be a web. Although water is used as the varnish viscosity reducing agent 53, another liquid having the function of reducing the viscosity of the varnish may be employed. The varnish viscosity reducing agent 53 need not be liquid but may be powder. After emergency stop, the varnish viscosity reducing agent 53 is supplied before coating is performed. If the sheet is to be conveyed by the blanket cylinder 26 without applying a printing pressure to the sheet by the upper blanket cylinder 25 before coating, the varnish viscosity reducing agent 53 may be supplied before conveying the sheet by the blanket cylinder 26, that is, before the sheet comes into contact with the upper blanket cylinder 25 and blanket cylinder 26.

As has been described above, according to the present invention, after the printing press stops emergently, the varnish viscosity reducing agent is gradually supplied to the supply cylinder. Therefore, the viscosity of the varnish/ink remaining on the supply cylinder does not increase, so that the sheet/web will not stick to the supply cylinder when the printing operation is resumed. Therefore, the operation of removing the sheet/web from the varnish supply cylinder or ink supply cylinder becomes unnecessary. This decreases the work load to the operator and improves the productivity.

What is claimed is:

1. A liquid transfer apparatus comprising:
a supply cylinder which comes into contact with a transfer target body and supplies a transfer liquid to the transfer target body; and
viscosity reducing agent supply means for supplying a viscosity reducing agent which reduces a viscosity of the transfer liquid to said supply cylinder after said apparatus emergently stops and before said supply cylinder starts transfer.

2. An apparatus according to claim 1, further comprising a controller which controls operation of supplying the viscosity reducing agent by said viscosity reducing agent supply means when said apparatus stops emergently.

3. An apparatus according to claim 2, further comprising abnormality detection means for detecting an abnormality in one of said apparatus and the transfer target body,
wherein when said abnormality detection means detects an abnormality in one of said apparatus and the transfer target body, said controller stops said apparatus emergently and controls said viscosity reducing agent supply means.

4. An apparatus according to claim 2, further comprising an emergency impression throw-off switch which instructs emergency impression throw-off upon manipulation by an operator,
wherein when said emergency impression throw-off switch is manipulated, said controller performs impression throw-off of said apparatus and controls said viscosity reducing agent supply means.

5. An apparatus according to claim 2, wherein said controller controls said viscosity reducing agent supply means so as to supply the viscosity reducing agent to said supply cylinder after said apparatus stops emergently and before the transfer target body comes into contact with said supply cylinder.

6. An apparatus according to claim 2, further comprising setting means for setting a supply amount of the viscosity reducing agent to be supplied by said viscosity reducing agent supply means,
wherein said controller controls said viscosity reducing agent supply means in accordance with the supply amount set in said setting means.

7. An apparatus according to claim 6,
wherein said viscosity reducing agent supply means comprises a spray which supplies the viscosity reducing agent to a circumferential surface of the supply cylinder, and
said setting means sets a spray frequency of said spray for said supply cylinder.

8. An apparatus according to claim 1, further comprising
first liquid supply means for supplying the transfer liquid to a first cylinder,
a second cylinder, serving as said supply cylinder, which performs transfer to one surface of the transfer target body with the transfer liquid transferred from said first cylinder,
a third cylinder, serving as said supply cylinder, which is arranged to oppose said second cylinder and performs transfer to the other surface of the transfer target body, and
second liquid supply means for supplying the transfer liquid to said third cylinder,
wherein said viscosity reducing agent supply means supplies the viscosity reducing agent to at least one of said first cylinder and said third cylinder.

9. An apparatus according to claim 8, wherein said viscosity reducing agent supply means comprises
a first viscosity reducing agent supply device which supplies the viscosity reducing agent to said first cylinder, and
a second viscosity reducing agent supply device which supplies the viscosity reducing agent to said third cylinder.

10. An apparatus according to claim 8, wherein said first cylinder comprises a plate cylinder, said second cylinder comprises a first blanket cylinder, and said third cylinder comprises a second blanket cylinder.

11. An apparatus according to claim 2, wherein when a viscosity reducing agent supply range of said viscosity reducing agent supply means includes a notch of said supply cylinder, said control means stops supply operation of said viscosity reducing agent supply means so as not to supply the viscosity reducing agent to said notch.

12. An apparatus according to claim 1, wherein said control means controls said viscosity reducing agent supply means to supply the viscosity reducing agent, which reduces a viscosity of the transfer liquid to be transferred first to the transfer target body at the start of transfer, to said supply cylinder.
